(19) United States
(12) Patent Application Publication
(10) Pub. No.: US 2016/0055186 A1
(43) Pub. Date: Feb. 25, 2016

(54) APPARATUS AND METHOD FOR OPTIMIZING TIME SERIES DATA STORAGE BASED UPON PRIORITIZATION

(71) Applicant: GE Intelligent Platforms, Inc., Charlottesville, VA (US)

(72) Inventors: Brian Scott COURTNEY, Naperville, IL (US); John Alan INTERRANTE, Scotia, NY (US); Kareem Sherif AGGOUR, Niskayuna, NY (US); Jenny Marie Weisenberg WILLIAMS, Niskayuna, NY (US); Ward Linscott BOWMAN, Mendon, MA (US); Jerry LIN, Seattle, WA (US); Sunil Mathur, East Walpole, MA (US); Justin DeSpenza MCHUGH, Latham, NY (US)

(21) Appl. No.: 14/777,867

(22) PCT Filed: Mar. 18, 2013
(86) PCT No.: PCT/US2013/032803

§ 371 Date: Sep. 17, 2015

(51) Int. Cl. G06F 17/30

(52) U.S. Cl. CPC G06F 17/30312; G06F 17/30306

(57) ABSTRACT

A data storage policy is determined. Time series data is received and a score for the time series data is determined. The score prioritizes the time series data according to a likelihood the time series data will be needed for future use. Based upon the data storage policy and the score, the time series data is stored at one or more data storage devices. The score is updated over time to reflect changing priorities regarding the use of the data.

### CROSS REFERENCES TO RELATED APPLICATIONS

International application no. PCT/US2013/032802 filed Mar. 18, 2013 and published as WO2014149026 A1 on Sep. 25, 2014 and entitled “Apparatus and method for Memory Storage and Analytic Execution of Time Series Data”;

International application no. PCT/US2013/032810 filed Mar. 18, 2013 and published as WO2014149029 A1 on Sep. 25, 2014 and entitled “Apparatus and Method for Executing Parallel Time Series Data Analytics”;

International application no. PCT/US2013/032823 filed Mar. 18, 2013 and published as WO2014149031 A1 on Sep. 25, 2014 and entitled “Apparatus and Method for Time Series Query Packaging”;

International application no. PCT/US2013/032806 filed Mar. 18, 2013and published as WO2014149028 A1 on Sep. 25, 2014 and entitled “Apparatus and Method for Optimizing Time Data Storage”;

International application no. PCT/US2013/032801 filed Mar. 18, 2013 and published as WO2014149025 A1 on Sep. 25, 2014 and entitled “Apparatus and Method for Optimizing Time Data Store Usage”;

are being filed on the same date as the present application, the contents of which are incorporated herein by reference in their entireties.

### BACKGROUND OF THE INVENTION

1. Field of the Invention

The subject matter disclosed herein relates to the storage of time series data and, more specifically, to storing time series data based upon a prioritization of the data.

2. Brief Description of the Related Art

Modern software systems are expected to handle an ever growing volume of data, and major challenges often arise in storing and accessing the data in a cost effective manner. Specifically, previous data storage and access mechanisms struggle with and in many cases are unable to meet the performance demands that systems have for querying and accessing data. Storing all of the data for a system in a single database running on a single computer may have been sufficient in the past, but as data volumes have grown by ten or one hundred times (or more) beyond their original planned sizes for many of these systems, the ability to query and analyze the data within a desired amount of time becomes a challenge.

One particular type of data that is stored is time series data. In one aspect, time series data is obtained by some type of sensor or measurement device and is stored as a function of time. For example, a measurement sensor may take a reading of a parameter every so often, and each of the measurements is stored in memory. Since large amounts of data are typically involved with time series measurements, the storage of this data becomes a particularly important concern.

Previous attempts at addressing these concerns continue to store all of the data together in a single medium. This meant that a user had to purchase enough storage space of that specific medium to handle all of the data, which could be an unnecessarily expensive result.

Unfortunately, the previous attempts have not been successful in the efficient storage and management of large amounts of time series data. As a result, user dissatisfaction with these previous approaches has resulted.

### BRIEF DESCRIPTION OF THE INVENTION

Embodiments of the present invention address the challenge of storing, accessing, and otherwise managing large amounts of time series data by “scoring” time series data in regards to the data access requirements for each record, segment, or portion, the time series data. The score prioritizes the time series data by inherently indicating how likely it will be needed for processing in the near future (e.g., within a predetermined time period). Each record or segment of the time series data can then be held within a different storage medium, depending on how quickly access to that particular time series data is required. For instance, time series data elements that are needed quickly can be stored in a fast medium such as directly in memory, and data that is used very rarely can be stored in a slow medium such as Network-Attached Storage (NAS).

In the embodiments of the present invention described herein, different storage media are used to store different portions of time series data because, for example, storage media have very different costs. For example, the fastest storage medium is usually the most expensive. As a result, embodiments of the present invention incorporate and utilize different storage media to minimize the need to purchase large amounts of the most expensive storage media. Moreover, to minimize system cost the embodiments described herein are selective in what data is stored within each medium. Another embodiment of the present invention, scores the time series data and moves the data from one storage medium to another based upon how the scores change over time.

In many of these embodiments, a data storage policy is determined Time series data is received and a score for the time series data is determined The score prioritizes the time series data according to a likelihood the time series data will be needed for future use. Based upon the data storage policy and the score, the time series data is stored at one or more data storage devices.

In some aspects, the data storage policy defines a type of data storage media to store the time series data. In other aspects, the score of the time series data is determined by one or more factors such as a user configuration, an age of the time series data, a last usage of the time series data, a frequency of usage of the time series data, a known future scheduled use of the time series data, an amount of storage space at each storage media, or a cost of storage of the time series data.

In other aspects, the score of the time series data is periodically and continuously updated. In other examples, the time series data includes first time series data and second time series data. The data storage policy routes the first time series data to a slow but inexpensive storage media and the second time series data to a fast but expensive storage media.

In still other aspects, the one or more data storage devices may be a memory, a Solid State Drive, a local disk drive or Network-Attached Storage (NAS). Other examples of data storage devices are possible.

In some examples, as the score (priority) of the time series data decreases, the time series data is moved to a lower cost data storage device compared to an existing data storage device of the time series data. In other examples, as the score (priority) of the time series data increases, the time series data is moved to a faster data storage device compared to an existing data storage device of the time series data.

In others of these embodiments, an apparatus that is configured to optimize data storage includes an interface and a processor. The interface includes an input and an output. The processor is coupled to the interface and is configured to receive time series data at the input. The processor is configured to determine a score for the time series data. The score prioritizes the time series data according to the likelihood that the time series data will be needed for future use. The processor is further configured to, based upon a data storage policy and the score, store the time series data at one or more data storage devices via the output.

### BRIEF DESCRIPTION OF THE DRAWINGS

For a more complete understanding of the disclosure, reference should be made to the following detailed description and accompanying drawings wherein:

FIG. 1 comprises a flow chart of an embodiment for optimizing data storage according to various embodiments of the present invention;

FIG. 2 comprises a block diagram of a system for optimizing data storage according to various embodiments of the present invention;

FIG. 3 comprises a block diagram of an apparatus for optimizing data storage according to various embodiments of the present invention;

FIG. 4 comprises a block diagram of an embodiment for determining a score according to various embodiments of the present invention; and

FIG. 5 comprises a block diagram showing a relationship between scores and a policy according to various embodiments of the present invention.

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION OF THE INVENTION

In the embodiments of the present invention described herein, a score is maintained or determined for each record or segment of time series data. The score is calculated based on several factors such as the user configuration, the age of the data, the last usage of the data, the frequency of usage of the data, the known future scheduled use of the data, the amount of space in each storage medium, and the cost of storage in each location. The scores of each record or segment are continually being updated, and the data is ranked according to their scores. In one aspect, the highest scoring data elements are kept in the first tier storage medium (e.g., the fastest storage), the next highest scoring records or segments are stored in the second tier storage medium (e.g., the second fastest storage), and so forth.

In some aspects, as the scores for a segment of data drop, the data is moved to lower cost storage, or as the score of the data increases (indicating an increased need for that data), the time series data is moved into faster and faster storage.

It will be appreciated that there are no strict cut-offs between scores and storage decisions because the amount of space available in each storage medium will change from system to system, and even the available storage media options are likely to change from deployment to deployment. For instance, one system may have four tiers such as memory, Solid State Drives, local disk drives and NAS, and another system may have only three such as memory, local disk and NAS.

Time series data is traditionally stored at a fixed cost, where all of the data is stored together in either memory or on disk. The ability of the present embodiments to take advantage of different storage media with different performance characteristics provides the ability to design systems that meet data access performance requirements without incurring the expense of purchasing excessive amounts of very fast but also very expensive storage media. By placing the high value time series data on very fast media and low value data in successively slower media, systems can be developed that meet performance criteria while minimizing cost. And as the value of the data changes over time, the system can automatically move the data across the storage media and this is completely transparent to the end user.

The embodiments provided herein are able to meet customer performance requirements without having to be overly expensive resulting in more cost-effective solutions than currently available. Without the present embodiments, users must purchase large volumes of expensive storage media to keep large volumes of the data in a highly accessible state, or they would be unable to meet any very low latency performance requirements.

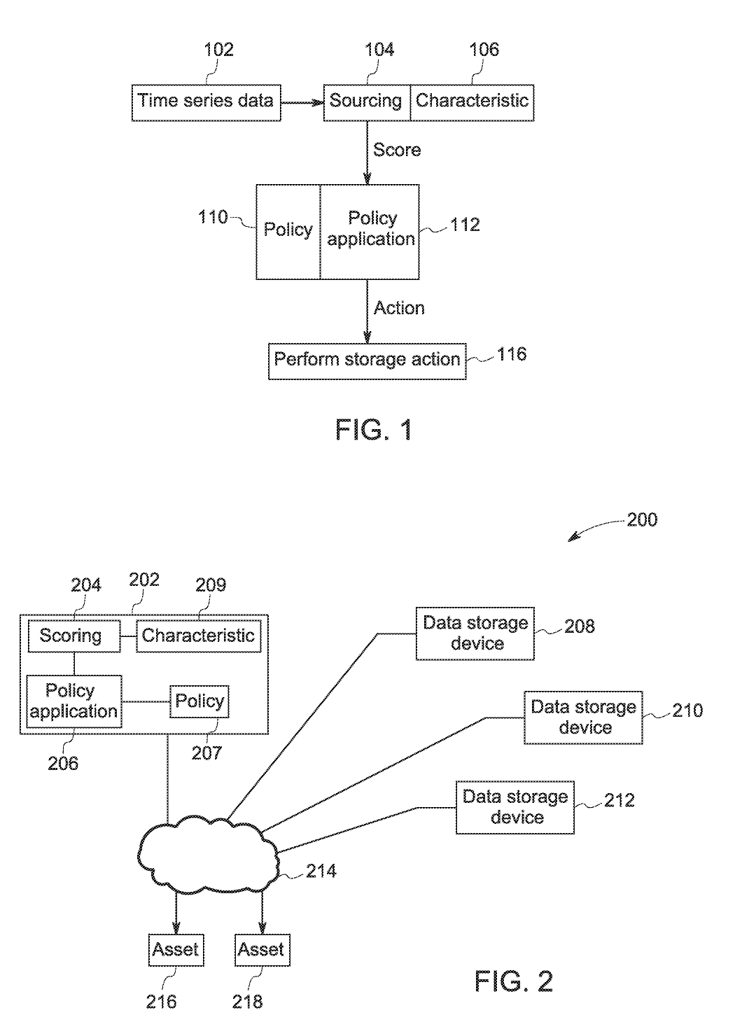

Referring now to FIG. 1, one example of an embodiment for optimizing data storage is described. At step 104, time series data 102 is scored. The score is determined according to one or more characteristics 106. For example, the characteristics 106 may include a user configuration, an age of the time series data, a last usage of the time series data, a frequency of usage of the time series data, a known future scheduled use of the time series data, an amount of storage space at storage media, or a cost of storage of the time series data. Other examples of characteristics are possible. The time series data 102 may be already created data (that is already stored and may need to be re-scored) or newly created data that is arriving from, for example, a measurement device on an asset. The score itself is typically a numerical indicator and may be an integer or real number to mention two examples.

A policy 110 defines rules by which the scored time series data is stored. In the respect, policy application module 112 applies the policy to the time series data to produce an action. The policy 110 may define rules that as the score for the time series data decreases, the time series data is moved to a lower cost data storage device compared to an existing data storage device of the time series data. In other examples, as the score of the time series data increases, the time series data is moved to a faster data storage device compared to an existing data storage device of the time series data.

The action specifies where to store the data. At step 116, the action is performed and the time series data is stored in the appropriate storage device.

Referring now to FIG. 2, one example of a system 200 that optimizes data storage is described. The system 200 includes an optimization apparatus 202 (that includes a scoring module 204, a policy application module 206, characteristic information 205, and a policy 207), a first data storage device 208, a second data storage device 210, a third data storage device 212, a network 214, a first asset 216, and a second asset 218.

The scoring module 204 uses characteristic information 205 to score time series data. Once scored, the policy application module 206 uses a policy 207 to determine which of the data storage devices 208, 210, or 212 are used to store the scored time series data. In one example, the score of the time series data is determined by use of one or more of a user configuration, an age of the time series data, a last usage of the time series data, a frequency of usage of the time series data, a known future scheduled use of the time series data, an amount of storage space at a storage media, or a cost of storage of the time series data. The exact weight given each factor will vary. Various scoring algorithms can be used (e.g., assigning all of the factors equal weight) and these algorithms will not be discussed further here. The scoring module 204 and the policy application module 206, in one example, are programmed software that is executed on a processing device.

The policy 207 defines rules that as the score for the time series data decreases, the time series data is moved to a lower cost data storage device compared to an existing data storage device of the time series data. In other examples, as the score of the time series data increases, the time series data is moved to a faster data storage device compared to an existing data storage device of the time series data. In some aspects, the score prioritizes the time series data according to a likelihood the time series data will be needed for future use. Based upon the data storage policy and the score, the time series data is stored at one or more data storage devices 208, 210, or 212. The policy 207 may be implemented as a data structure, programmed software operating on a processing device, hardware, or combinations of these elements.

The first data storage device 208, second data storage device 210, and third data storage device 212 are any type of data storage device, permanent or temporary. For example, these devices could be a Solid State Drive, a local disk drives or Network-Attached Storage (NAS).

The network 214 is any type of network or any combination of networks such as cellular phone networks, the Internet, data networks, that allow the assets to communicate with the optimization apparatus 202 and the data storage devices 208, 210, and 212. It will be appreciated that the example of FIG. 2 is one example of a system architecture and that other examples are possible.

The first asset 216 and second asset 218 are any type of device that produces time series data. In one aspect, time series data is obtained by some type of sensor or measurement device and that is stored as a function of time. For example, a measurement sensor may take a reading of a parameter ever so often, and each of the measurements is stored.

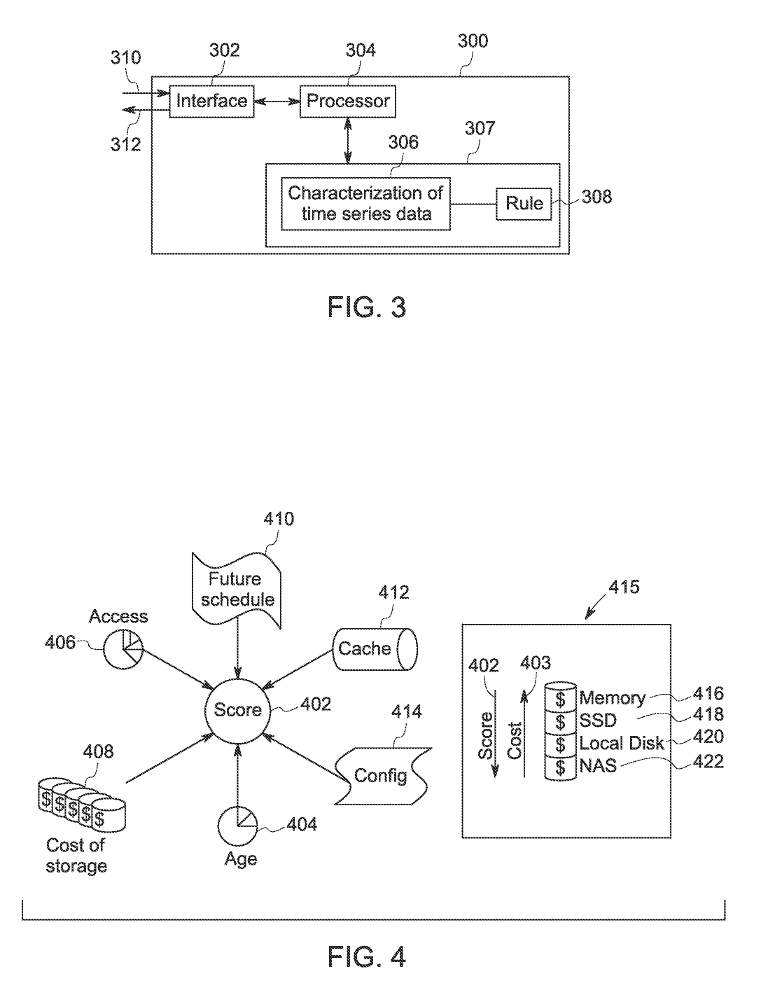

Referring now to FIG. 3, an apparatus 300 for optimizing data storage includes an interface 302 and a processor 304. The interface 302 includes an input 310 and an output 312. The apparatus 300 may be located on any processing device such as a server or combination of servers. The processor 304 implements programmed software instructions to implement the embodiments described herein.

The processor 304 is coupled to the interface 302 and is configured to receive time series data at the input 310. The processor 304 is configured to determine a score for the time series data. The score prioritizes the time series data according to the likelihood that the time series data will be needed for future use. The score is based upon one or more characteristics 306 stored in a storage medium 307. The processor 304 is further configured to, based upon a data storage policy 308 (also stored in the storage medium 307) and the score, store the time series data at one or more data storage devices via the output 312.

Referring now to FIG. 4, one example of determining a score 402 is described. As shown, the score 402 may be determined by a number of factors. In this case, the age of the data 404 may be used to calculate the score 402. Access requirements 406 to the data may also be used to calculate the score 402. The cost of storage 408 may also be used to calculate the score 402.

Furthermore, future schedule information 410 may be used to calculate the score 402. This includes, for example, monthly or quarterly scheduled processing tasks. Available cache information 412 may be used to calculate the score 402. The available cache information 412 may include understanding how much of each storage device is already consumed by existing time series data. Configuration information 414 may be used to calculate the score 402. The configuration information 414 may include user-defined storage requirements to, for example, indicate that the most recent week of data must always be kept in the fastest storage device.

Once the score 402 is calculated, a policy 415 is illustrated. The policy 415 relates to the score 402 and cost 403. The direction of the arrows associated with the score 402 and the cost 403 indicate increasing scores or cost. Thus, as the score increases, data may be placed/moved into a memory 416, then into a Solid-State Device (SSD) 418, then in a local disk 420, and finally into a Network-Attached Storage (NAS) device 422. Additionally, as the score increases, the time series data is placed/moved into NAS device 422, then local disk 420, then SSD 418 and then memory 416.

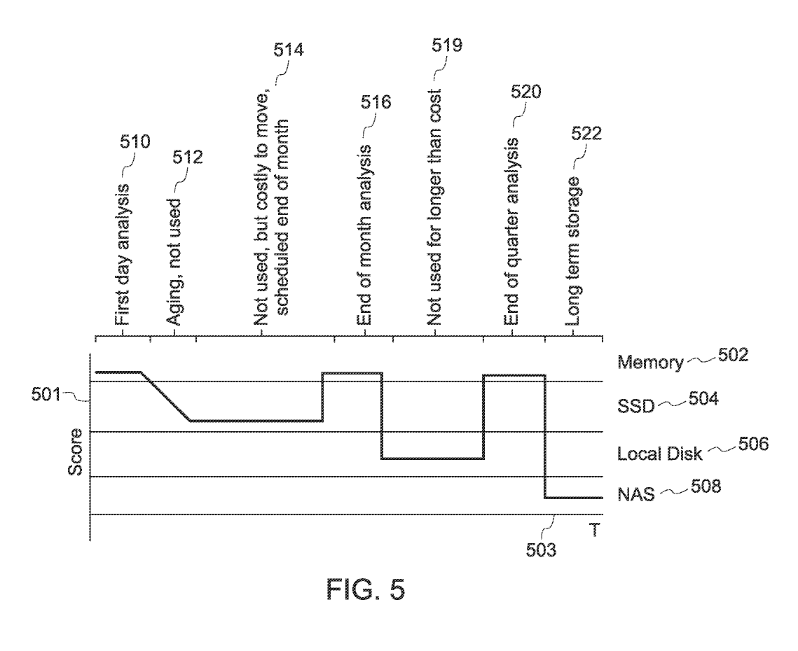

Referring now to FIG. 5, a relationship between scores and a policy is described. A score 501 is shown along the y-axis and time 503 is shown along the x-axis. As time progresses, the score 501 changes and data is stored in a different place according to the policy. In this example, the four places where data can be stored are in a memory 502, an SSD 504, a local disk 506, and NAS 508.

At a first time 510, first day analysis occurs and the score 501 is relatively high. The data is therefore stored in memory 502 at first. At a second time 512, the data has aged and is not currently in use. The score 501 thus decreases, and the data is moved to the SSD 504 during this time. At a third time 514, the data is not used but is costly to move. The score 501 thus remains the same and the data remains in the SSD 504 during this time. At a fourth time 516, an end of month analysis occurs, which requires the data. Thus, the score 501 increases. Data is moved to SSD 504 during this time. At a fifth time 518, the data is not used for longer. The score 501 decreases. Data is moved to the local disk 506 during this time. At a sixth time 520, end of quarter analysis occurs, again requiring the data. The score 501 increases. Data is moved to memory 502 during this time.

At a seventh time 522, the data is not used often and is destined for long term storage. The score 501 has decreased to its lowest level. The data is moved to the NAS 508 during this time.

It will be appreciated by those skilled in the art that modifications to the foregoing embodiments may be made in various aspects. Other variations clearly would also work, and are within the scope and spirit of the invention. The present invention is set forth with particularity in the appended claims. It is deemed that the spirit and scope of the invention encompasses such modifications and alterations to the embodiments herein as would be apparent to one of ordinary skill in the art and familiar with the teachings of the present application.

What is claimed is:

1. A method for optimizing time series data storage, the method comprising:
defining a data storage policy;
receiving time series data;
determining a score for the time series data, the score prioritizing the time series data according to a likelihood the time series data will be needed for future use; and
based upon the data storage policy and the score, storing the time series data at one or more data storage devices.

2. The method of claim 1 wherein the data storage policy defines a type of data storage media to store the time series data.

3. The method of claim 1 wherein the score of the time series data is determined by at least one characteristic selected from the group consisting of: a user configuration; an age of the time series data; a last usage of the time series data; a frequency of usage of the time series data; a known future scheduled use of the time series data; an amount of storage space at storage media; and a cost of storage of the time series data.

4. The method of claim 1 wherein the score of the time series data is periodically updated.

5. The method of claim 1 wherein the time series data comprises first time series data and second time series data, and wherein the data storage policy routes the first time series data to an inexpensive storage media and the second time series data to an expensive storage media.

6. The method of claim 1 wherein the one or more data storage devices are selected from the group consisting of memory, Solid State Drives, local disk drives and Network-Attached Storage (NAS).

7. The method of claim 1 wherein the storing comprises as the score for the time series data decreases, moving the time series data to a lower cost data storage device compared to an existing data storage device of the time series data.

8. The method of claim 1 wherein the storing comprises as the score of the time series data increases, moving the time series data to a faster data storage device compared to an existing data storage device of the time series data.

9. An apparatus that is configured to optimize data storage, comprising:
an interface with an input and an output;
a processor coupled to the interface, the processor configured to receive time series data at the input, the processor configured to determine a score for the time series data, the score prioritizing the time series data according to a likelihood the time series data will be needed for future use, the processor configured to, based upon a data storage policy and the score, store the time series data at one or more data storage devices via the output.

10. The apparatus of claim 9 wherein the data storage policy defines a type of data storage media to store the time series data.

11. The apparatus of claim 9 wherein the score of the time series data is determined by at least one characteristic selected from the group consisting of: a user configuration; an age of the time series data; a last usage of the time series data; a frequency of usage of the time series data; a known future scheduled use of the time series data; an amount of storage space at storage media; and a cost of storage of the time series data.

12. The apparatus of claim 9 wherein the score of the time series data is periodically updated by the processor.

13. The apparatus of claim 9 wherein the time series data comprises first time series data and second time series data, and wherein the data storage policy routes the first time series data to an inexpensive storage media and the second time series data to an expensive storage media.

14. The apparatus of claim 9 wherein the one or more data storage devices are selected from the group consisting of memory, Solid State Drives, local disk drives and Network-Attached Storage (NAS).

15. The apparatus of claim 9 wherein the processor is configured to, as the score for the time series data decreases, move the time series data to a lower cost data storage device compared to an existing data storage device of the time series data.

16. The apparatus of claim 9 wherein the processor is configured to, as the score of the time series data increases, move the time series data to a faster data storage device compared to an existing data storage device of the time series data.
